(19) United States
(12) Patent Application Publication
(10) Pub. No.: US 2012/0132630 A1
(43) Pub. Date: May 31, 2012

(54) Method and Device for Laser Inscribing

(75) Inventors: Rudiger Kreuter, Darmstadt (DE); Willi Koschinski, Langen (DE)

(73) Assignee: Nanosec Gesellschaft Für Nanotechnologie In Der Sicherheitstechnik MBH, Darmstadt (DE)

(21) Appl. No.: 13/382,098

(22) PCT Filed: May 26, 2010
(86) PCT No.: PCT/EP2010/057203

§ 371 Date: Jan. 27, 2012

(30) Foreign Application Priority Data
Jul. 6, 2009 (DE) 10 2009 031 871.2

(51) Int. Cl. B23K 26/00

(52) U.S. Cl. 219/121.72; 219/121.67

(57) ABSTRACT

In order to obtain a laser inscribing unit that is compact for inscribing cards on two sides which also includes a magnet chip inscribing unit, a laser beam is only deflected in one spatial direction in a fan shape, and in the other spatial direction the movement of the card received in the card slide is provided. In spite of inscribing the card in the same receiving position from the top side and also from the bottom side this yields a very compact configuration.

### FIELD OF THE INVENTION

The invention relates to laser inscribing of card type substrates, e.g. ID cards, credit cards, check cards or similar flat, planar objects with two main surfaces extending parallel to one another wherein at least one of the surfaces is to be inscribed.

### BACKGROUND OF THE INVENTION

Inscribing cards, in particular made from plastic material, through a laser is known in the art since the energy of the laser beam causes a carbonization and thus blackening of the carbon of the substrate and thus a permanent coloration with a depth effect in the base material.

The coloration can be provided through absorption of the laser light through the substrate or portion of the substrate like e.g. embedded colorants etc. and through cracking encapsulating pigments open.

Depending on the energy of the laser light and the positioning of the focal point, the inscribing effect can be provided at the surface or also in the depth of the substrate, wherein the latter is typically only used when a transparent cover layer that is at least transparent for the laser radiation is arranged above the influenced layer so that the color change provided by the laser which can be a lettering and also an image depiction is detectable with a bare eye.

Another method is introducing energy through a laser into a plastic material that expands under heat impact which facilitates generating a raised contour, thus lettering on a card surface that was even before.

Since cards of this type typically have to be inscribed in large numbers and the color change has to be generated with the laser beam pixel by pixel on the card the laser aperture, in particular the laser source is arranged perpendicular to the main plane of the card to be inscribed in prior art inscribing devices and the beam is deflected through moveable deflection mirrors in X-direction and in Y-direction of the main plane of the card so that the desired inscribing is provided on a stationary card.

Since the respective deflection mirrors or polygon mirrors, the further away they are from the card to be inscribed only have to be rotated by very small angles and movement paths, this movement of the deflection mirrors and thus inscribing of the card can be performed very quickly.

This, however, causes rather large overall dimensions of the laser inscribing device

However if the card shall be additionally inscribed on both sides through the laser either the card has to be reversed for inscribing the backside and reinserted into the device or the device which is rather tall anyhow is configured redundant and doubled up for inscribing the top side and the bottom side and thus has a size that is doubled up once more.

### DETAILED DESCRIPTION OF THE INVENTION

### Technical Object

Thus it is the object of the invention to provide a method and device for laser inscribing cards which has small dimensions in spite of simple and cost efficient configuration and still facilitates fast inscribing.

### Solution

This object is achieved through the features of claims 1 and 20. Advantageous embodiments can be derived from the dependent claims.

A very compact configuration is provided in that the relative deflection of the laser beam with respect to the card surface is only implemented in one direction, e.g. the Y direction by the laser beam through respective beam routing, thus in particular through deflection mirrors, e.g. a galvanometer mirror or a rotating polygon mirror and other deflection mirrors, while the movement in the other direction, the X-direction is implemented through movement of the card in that the card is fixated in a card slide that its moveable in this direction. Instead of the movement of the substrate (card) also a movement at least of the last deflection mirror can be provided along the substrate as so called “optical slide”.

The reason is that through the deflection of the laser beam in only one direction the laser beam instead of having to be spread into a three dimensional cone only has to be spread into a two dimensional fan. Therefore the respective deflection mirror only has to have a significant extension in one direction, namely the width of the fan and can be configured very narrow in the other spatial direction. This is one of the reasons why the device can be configured overall smaller and more compact.

The fact that the card slide (optical slide in case the movement of the last slide) cannot be accelerated and moved as quickly as a light deflection mirror due to its much higher mass only leads to a strong increase of the inscribing time at first glance, since the card slide (optical slide) does not have to be moved for inscribing each particular pixel but plural, preferably all Y-positions are inscribed in an X-position of the card slide or optical slide, so that the card slide only has to be accelerated according to the number of X-positions into which it is moved.

In the present configuration the movement direction of the card slide or of the optical slide is the larger of the two main orientations of the card, since the magnet-/chip inscribing device that is arranged in front pulls in the cards in this direction.

Another speed increase however can be obtained in that the movement direction of the card slide or the optical slide is the smaller of the two main directions of the card.

Since the moveable galvanometer mirror or polygon mirror, subsequently designated as fan mirror which deflects the laser beam in the space of a fan, is moved in increments according to the Y-positions of the pixels to be inscribed on the card, a control is required which controls the laser according to the angular position of the fan mirror and additionally also according to a current X-position of the card slide or the optical slide, thus causes a laser impact at the desired X-Y position and thus also controls the power of the laser.

Thus preferably inscribing portions with required uniform laser settings like in particular laser impulse frequency and laser impulse duration are produced in one pass and the laser settings are subsequently changed and then the inscribing portions are inscribed which require a different laser power.

For example this applies to image representation of the card holder on the one hand side and writing on the card on the other hand side.

Another reduction of the size of the device is provided according to the invention when the card shall be inscribed on both sides.

In this case the card is only fixated in the receiver of the card slide along the edges which do not have to be inscribed, however its bottom side does not contact the card slide with its entire surface or is not covered by the card slide at the bottom side.

Thus, the inscriptions of both sides of the card can be provided in one receiving step in the card slide subsequent to one another from the top and also from the bottom.

For this purpose a selection mirror for the laser beam is provided which is in particular pivotable back and forth between two positions, wherein the selection mirror alternatively conducts the beam to the top side or the bottom side of the card received in the card holder.

The selection mirror is preferably arranged laterally adjacent to the card slide or the optical slide and its movement path and the selection mirror is arranged in the beam path still before the at least one stationary deflection mirror, however behind the fan mirror, wherein for this purpose the at least one deflection mirror has to be analogously provided on each of the two sides of the main plane of the card.

Preferably the selection mirror is pivoted between the two positions exactly by ninety degrees and the optical axis of the laser beam aperture extends parallel to the center main plane of the card slide, in particular on the center main plane mainly adjacent to the movement path of the card slide so that the selection mirror rotates about a pivot axis extending in y direction adjacent to the card slide.

Since a portion of the beam path is adjacent to the movement path of the card slide or optical slide, this does not require any installation height orthogonal to the card slide, or to the plane of the card slide.

Thus, the device becomes particularly simple in its configuration in that the laser beam is not deflected behind the selection mirror through the fixated deflection mirrors on each side of the main plane only by two deflection mirrors which are theoretically possible, but deflected through three deflection mirrors, wherein each of them provides a deflection by ninety degrees.

On the other hand side deflection mirrors with a reflection angle of this type can be purchased off the shelf and very economically, on the other hand side this has the effect at all deflection mirrors on each of the sides for double sided inscribing or six deflection mirrors are identical mirrors, thus due to identical reflection conditions have the same dielectric coating, namely a beam deflection of ninety degrees which would not be the case when using only two deflection mirrors on each side.

The deflection mirrors are thus mounted and adjusted so that the focal point of the laser beam is not always on the surface of the card arranged on the card slide, independently from the position of the moveable mirrors, thus the deflection mirror and the fan mirror are the only mirrors in the device which are moved during the inscribing process.

When a focal point below the surface of the card, thus in a lower layer of the card is required the three mirrors that are not moved during the inscribing process can be readjusted with respect to their distance to the card. An adjustment either of the guides for the card slide with respect to their elevation positions, thus transversal to the x y direction, or a replaceable receiver in the card slide, so that different receivers with different elevation positions of the card in the card slide are provided, can be performed when only one sided inscribing of the card has to be performed.

In order to simplify the control the movement path of the card slide is a straight, flat movement path and is additionally aligned with the movement path of the card on which the card passes through the magnet and/or chip inscribing device arranged in front.

In between, thus to the card slide and back again an automated handover is performed.

Since the cards to be inscribed are typically prepared in advance in a manner that is optically visible, thus are imprinted or embossed or similar and the imprinting or embossing elements due to manufacturing tolerances are not always exactly at the same target position of the card, the device preferably includes an optical sensor, in particular a CCD chip which determines the position of the visible elements applied in advance and when there is a deviation from the target position the optical sensor moves the laser inscribing accordingly with respect to its position through the control which is connected for this purpose with the optical sensor or the CCD chip.

Furthermore the device in spite of its compact configuration includes an extraction device for the air contaminated by combustion residues that is generated at the inscribing location through the laser burn in, wherein the air is extracted from the inscribing cavity that is arranged in a closed housing of the unit and conducted to the ambient through a charcoal filter, so that the ambient of the device is not contaminated by foul smelling or health hazardous substances.

Furthermore the device can be configured so that a surface is inscribed with the laser with an optical lens structure according to the CLI method or MLI method.

Since the laser beam for this purpose must not impact the surface of the card in an orthogonal manner as it can be provided in the basic version of the device according to the invention, a prism can automatically be moved into the beam path of the laser between the last deflection mirror and the card surface for deflecting the laser beam so that it impacts the card surface at a slant angle. The movement of the impact point of the laser beam on the card surface caused by the beam deflection is considered through computations of the control in retracted condition of the prism.

In case the slanted prism, depending on its effective direction, causes a deflection in x-direction this can be facilitated through respective approaching of another position through the card slide.

When this causes a deflection in y-direction, the movement of the impact point caused by the prism has to be compensated through the control of the fan mirror.

### EMBODIMENTS

Embodiments of the invention are subsequently described in more detail in drawing figures, wherein:

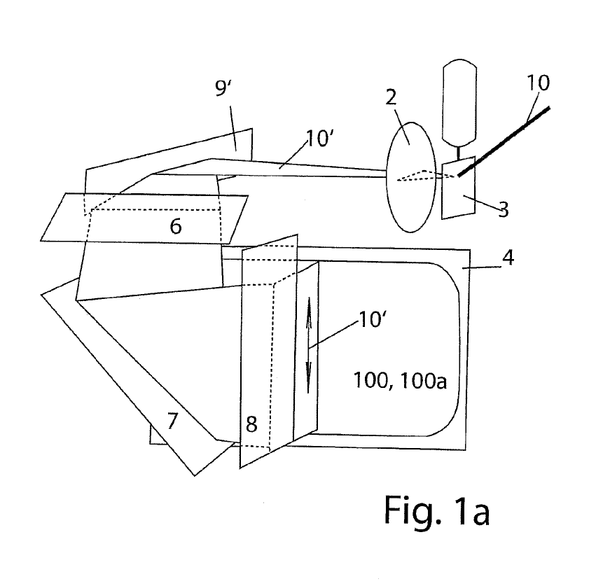

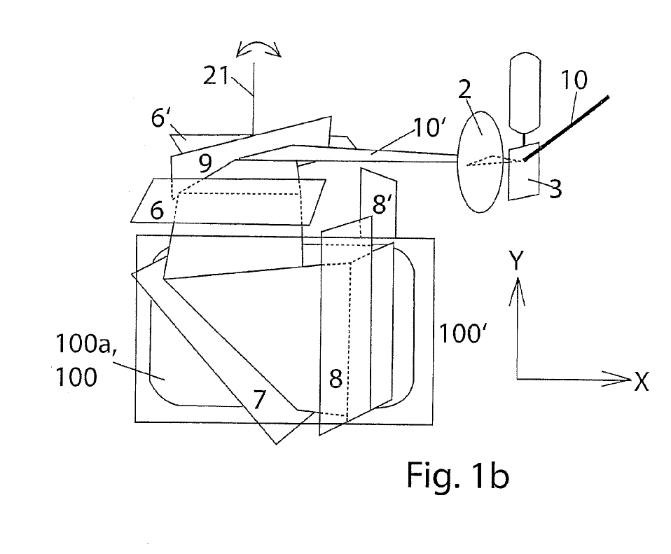

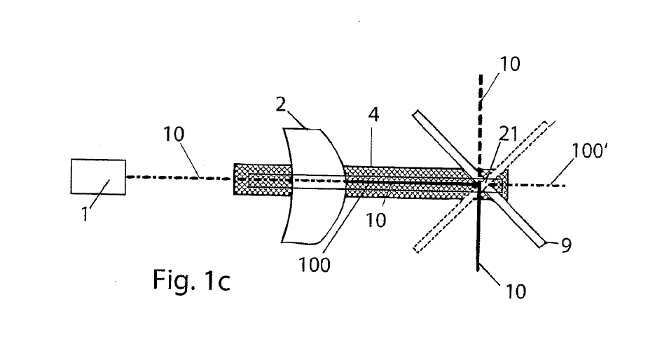

FIG. 1 illustrates block diagrams of the beam path;

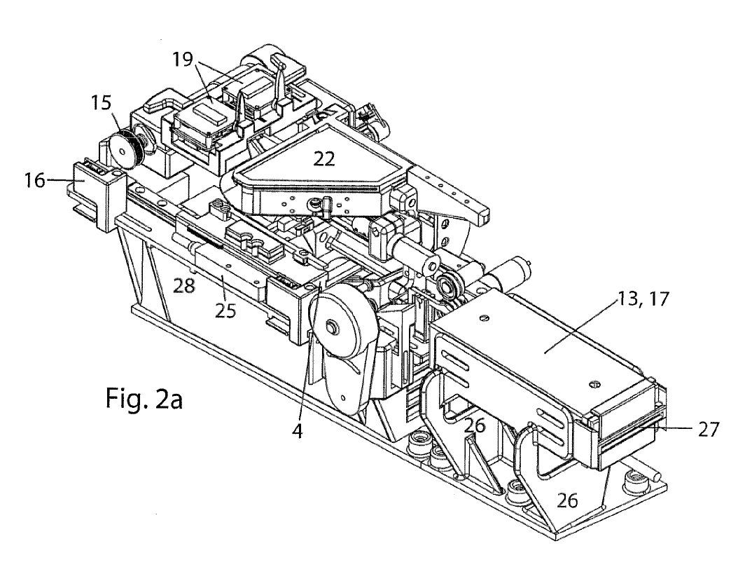

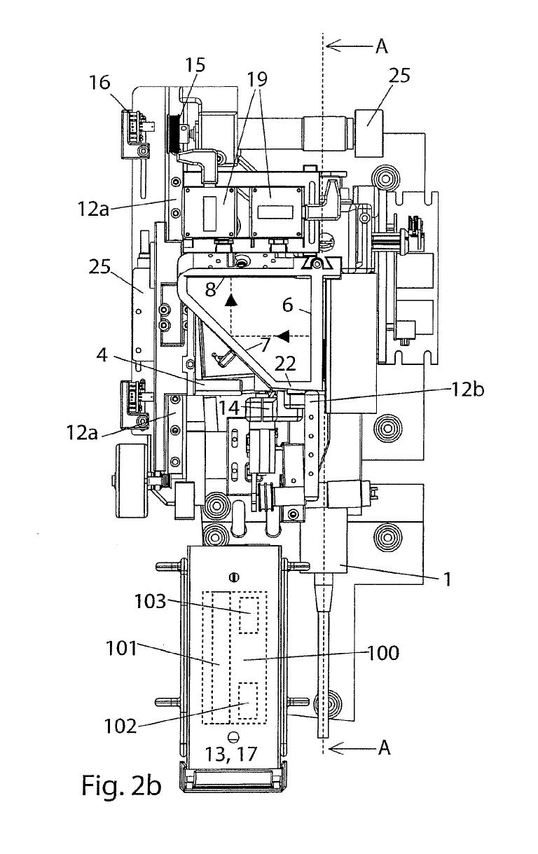

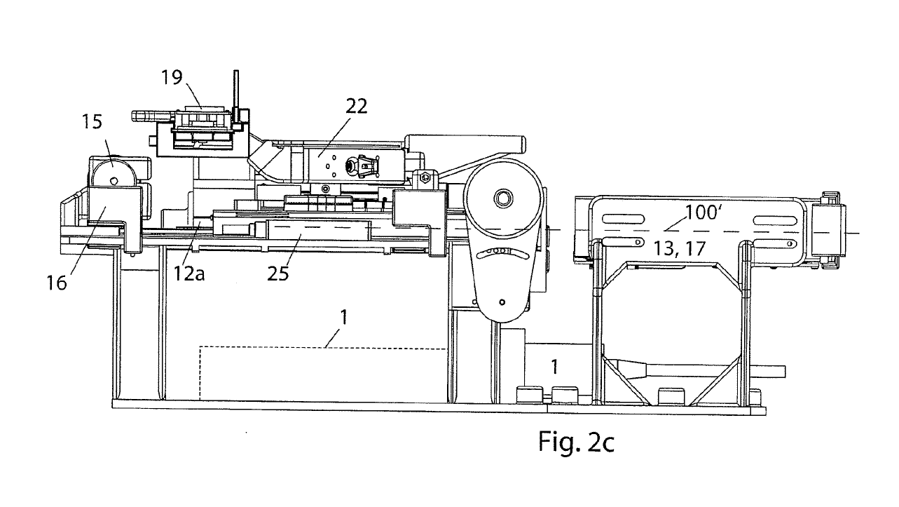

FIG. 2: illustrates a device according to the invention in various views; and

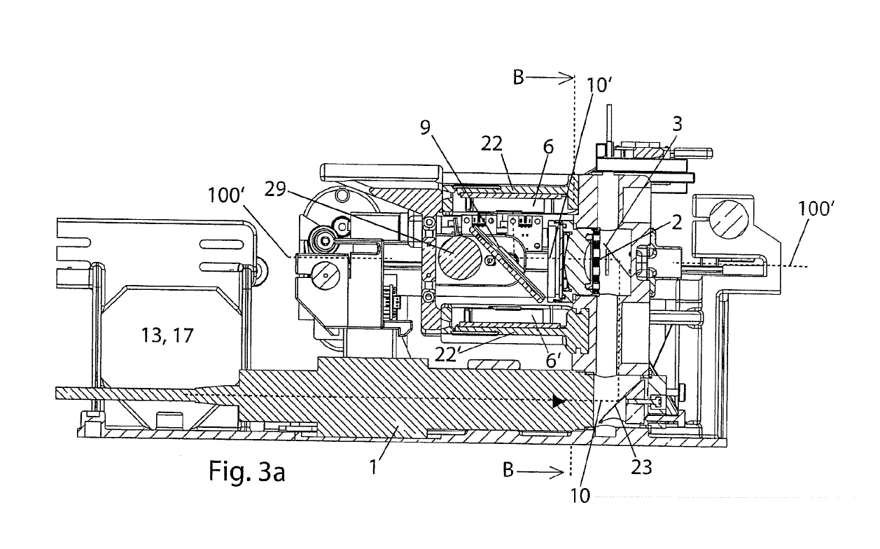

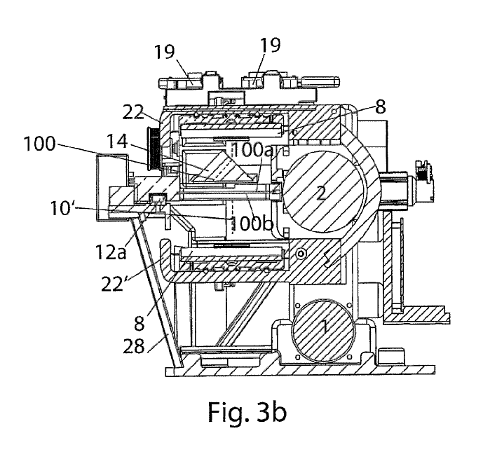

FIG. 3: illustrates sectional views of the device of FIG. 2.

FIG. 1a illustrates the rectangular card 100 that shall be inscribed and which has the typical rounded corners and which is received in a form locking manner in a card slide 4 which is moveable in a controlled manner in x-direction, in this case the larger direction of the main plane of the card 100, and thus of the card slide 4.

A laser beam 10 is initially fanned into a beam fan 10′ adjacent to the card slide 4 through a fan mirror 3 pivoting back and forth by a defined angular amount in an oscillating motion, wherein the fan mirror 3 is respectively stopped in an intermediary portion in increments at defined angular positions according to the different Y-positions on the card 100 that are to be reached, wherein the beam fan 10′ which provides a line of light extending in Y-direction or particular light dots lined up in Y-direction when the laser is active at each Y-position on the top side 100a of the card 100.

However since no continuous line shall be generated on the card, but only particular pixels as a function of the lettering to be generated shall be burned in, the control 5 controls the laser source 1 so that a pixel is burned into the top side of the card 100 through triggering a laser shot only for the desired angle position of the fan mirror 3, thus the desired Y-position and in particular with the card slide 4 in the predetermined X-position.

The beam fan 10′ is initially guided by the optics 2 which causes the focal point of the respective laser beam to always be on the surface of the card 100 in the card slide 4, thus neither too high, nor too low irrespective of the position in the beam path.

The beam fan 10 from the fan mirror 3 and after the optics 2 still extending parallel to the movement direction of the card slide 4 adjacent to the card slide 4 wherein the plane of the beam fan is orthogonal to the main plane 100′ of the card 100 received in a card slide 4, is respectively deflected by ninety degrees in the embodiment FIG. la sequentially by four sequentially arranged and fixated deflection mirrors 9′, 6, 7, 8 so that the last deflection generates a light line extending transversal to the movement direction, the X-direction of the card slide 4 over the entire width of the card 10, wherein the light line is an image of the beam fan 10′ on the card top side 100a.

The deflection mirrors 9′, 6, 7, 8 thus deflect the beam fan 10′ respectively by ninety degrees and have identical reflection properties in this respect and are produced in an identical manner, in particular provided with a particular dielectric coating and are therefore particularly economical.

Since the deflection mirrors 9′, 6, 7, 8 respectively have to deflect a beam fan 10′ they have a elongated small dimension with a length according to the width of the beam fan 10′ at this location or slightly larger, but a much smaller width.

This way the entire surface of the card besides the edge portions can be inscribed at will with numbers, letters, logos, an image of the card holder symbols of the card issuer through incremental movement of the card slide 4 in X-direction respectively by the distance of a pixel, wherein the card 100 is supported in the card slide 4 in the edge portions which shall not be inscribed anyhow.

Thus a first pass through of the card slide 4 in X-direction e.g. for lettering and possible another run over a limited dimension in X-direction is performed for an image to be produced with other laser settings.

FIG. 1b illustrates an arrangement which differs from the arrangement in FIG. 1 in that in particular a selection mirror 9 that is pivotable by ninety degrees is mounted instead of the former fixated deflection mirror 9′, wherein the selection mirror is rotatable about a pivot axis 21 which is arranged in parallel, in particular in the main plane 100′ of the card 100 arranged in the card slide 4, in this case the drawing plane.

The selection mirror 9 is thus pivotable between two end positions 21a, 21b which guide the beam fan 10′ alternatively into the portion above the main plane 100′ of the card 100 in the card slide 4 and thus to the deflection mirrors 6, 7, 8 according to FIG. 1a and from there to the top side 100a of the card 100, or in the other non illustrated end position of the selection mirror 9 into the portion below the main plane 100′ and through fixated deflection mirrors 6′, 7′, 8′ analogously provided at this location to the bottom side 1008 of the card 100.

FIG. 3a among other things illustrates the electric magnet 29 which pulls the selection mirror 9 in one or another end position as a function of the power loading.

Thus the selection mirror 9 does not continuously pivot back and forth but remains in one of its end positions until the inscribing of the top side 100a or the bottom side 100b of the card 100 is completed.

FIG. 1c in a lateral view of the arrangement in FIG. 1b illustrates that the laser beam 10 extends from the laser source 1 to the selection mirror 9 in one direction which does not only extend in parallel but in the center main plane 100′ of the card 100 inserted into the card slide 4, wherein the main plane is defined by the X and Y directions, thus the main extension directions of the card 100 and is arranged in the center of the thickness of the card body 100.

This has the advantage that the selection mirror 9 in its end positions has to be arranged at a +/−45 degree angle relative to the direction of the laser beam 1 and thus has to cover a defined pivot angle of ninety degrees with defined end positions which is rather easy to accomplish through a motor or an electric rotation magnet which is controlled accordingly.

Thus, the fanning of the laser beam 10 in a beam fan 10′ is not drawn for reasons of clarity.

The beam fan 10′ is guided by the second to last deflection mirror 7 into a direction opposite to the original beam direction from the fan mirror 3 to the subsequent next mirror which yields a particularly compact configuration of the device.

FIGS. 2 and 3 illustrate a particular device according to the invention in which non essential details as describe infra of the beam path slightly deviate from the details of the beam path in the block diagram 1.

Thus FIG. 2a illustrates a perspective view from the left top on the device, while FIG. 2b illustrates an exact top view and FIG. 2c illustrates and exact lateral view from the left.

FIG. 3a illustrate a longitudinal sectional view according to the line A-A of FIG. 2b and FIG. 3b illustrates a cross section B-B according to FIG. 3a.

As best apparent from FIGS. 2b and 3a the elongated tub shaped laser source 1 in top view is arranged in the right lower portion of the device and extends over 2/3 of the length of the device.

In order to keep the installed length of the device as short as possible the laser source 1 is therefore arranged below the center main plane 100′ and as evident in FIG. 3a is deflected through two deflections respectively by 90 degrees in a beam direction along the middle center section 100′, however still adjacent to the card slide 4 and behind the second one of the two deflection mirrors 23, 3 in a direction opposite to the original beam direction after the laser source 1.

Thus one of the two deflection mirrors, in this case the second of the two deflection mirrors can be moveably arranged as a fan mirror 3 in order to split the laser beam 10 into the desired beam fan 10′.

The beam fan 10′ is initially run through the focusing optics 2 and subsequently onto the pivotably arranged selection mirror 9 according to FIG. 1b, wherein the selection mirror 9 is at an end position in FIG. 3a so that the beam fan 100′ is deflected in upward direction, thus in a direction towards the top side 100a of the card slide 4 and from there onto the first deflection mirror 6 that is visible in FIG. 3a of the three fixated deflection mirrors 6, 7 and 8 which are received in the mirror support 22 as a fixated assembly which are configured in a mirror arrangement thus with analogous deflection mirrors 6′, 7′, 8′ which are also provided another time below the main center plane 100′ as evident in particular from FIG. 3a and FIG. 3b.

Differently from the basic illustration in FIGS. 1a and 1b thus the beam fan 10′ is not conducted against the original radiation direction of the laser source 1 through the second to last deflection mirror 7 or 7′, but parallel to its radiation direction which comes from the fact that in the present device the path of the opposite routing of the laser fan 10′ has already been provided in the portion between the fan mirror 3 and the selection mirror 9 in order to shorten the installed length.

From the last deflection mirror 8 or 8′ of the mirror supports 22 or 22′ the beam fan 10′ is radiated onto the card surface in an orthogonal manner as evident best in cross section from FIG. 3b when inscribing a bottom side 100b of the card 100.

Thus an additional prism 14 is inserted into the beam path between the last deflection mirror 8 and the top side 100a of the card 100 which deflects the beam fan 100′ viewed in longitudinal direction of the device and thus in movement direction of the card slide 4, in a lateral direction above the card 100 in FIG. 3b, so that the beam fan does not impact the top side 100a of the card 100 in an orthogonal manner anymore but at a slant angle. An analogous prism 14 can also be provided on the bottom side.

Thus on a card surface which includes an optical structure which is configured for CLI or MLI a laser inscribing is implemented on the card 100, so that depending on the viewing angle of the surface of the card 100 different images are visible to a viewer, e.g. an image burnt in by the laser 1 that is only recognizable from a certain viewing direction and not recognizable from other viewing angles.

The card slide 4 is moved back and forth by a motor 24 which is configured as a servo motor and which is arranged in the rear portion of the device, wherein the movement is performed through timing belts that are run through deflection sprockets and wherein the movement is performed along a movement path on supports 12a, b, wherein the exact longitudinal position in X-direction of the card slide 4 is detected and controlled through a linear incremental encoder 25 arranged laterally adjacent to the movement path, wherein the incremental encoder is configured as a magnetic or optical encoder.

In FIG. 2b, however, the prism 14 is in a deactivated pulled back position from which it can be automatically moved forward according to FIG. 2b under the last deflection mirror 8 of the fixated mirror supports 22.

In FIG. 2b furthermore two CCD-chips 19 are arranged above the main center plane 100′ and behind the mirror support 22 with a downward viewing direction onto the main center plane 100′ in order to initially measure after inserting the card 100 in the card slide 4, where the preprints 102 are located that are already provided on the card 100 in particular with respect to their absorption relative to the device.

For this purpose the movement path of the card slide 4 is configured sufficiently long in order to let the card slide 4 initially move under the CCD chips 19 before the beginning of the inscribing process, wherein the CCD chips initially detect the placement of the pre print 102 on the card 100 and optionally change the positioning of the laser inscribing on the card 100 when its actual position deviates too much from its target position or also identify the card blank as scrap and do not inscribe it.

For this purpose the two CCD chips 19 are respectively arranged in strips extending in X-direction and in Y-direction and are configured to detect side edges of a pre print that extend in these directions.

As furthermore illustrated in the figures an electronic inscribing unit 13 is arranged in front of the actual laser inscribing unit, wherein the electronic inscribing unit is typically mounted as a purchased item in front of the actual laser inscribing unit in a position, in this case on transversal support plates 26, so that the card 100 inserted into the insertion slot 27 at the front end of the unit 13/17 is moved forward through the independent transport devices in the interior of the unit and moved out at the lower end through an analogous outlet and is aligned with the subsequent movement part of the card slide 4 and extends horizontally like the subsequent movement path of the card slide 4.

Also transferring the card 100 from the unit 13/17 into the card slide 4 and back is provided automatically in that the card slide 4 in its start position is directly behind the inscribing unit 13/17 during handover and a card pushed out by this unit is directly pulled into the frame shaped card slide 4 through an electrically driven roller, wherein the card contacts the card slide with its edges in a narrow externally circumferential portion. When the card slide moves out of its starting position the card is supported from the top through a spring arm of the card slide 4 which is arranged at the end of the card slide 4 that is opposite to the inscribing unit 13/17 and under which the card 100 is automatically pushed by the card slide 13.

The card 100 inscribed by a laser is transported back on the same path after completion of the inscription, thus in that the card slide 4 moves back into the starting position and the card 100 is lifted automatically form the card slide 4 and inserted into the outlet of the electronic inscribing unit 13.

Therein the card 100 is captured transported through backward and ejected as a completely inscribed card from the insertion slot 27 at the front end of the unit 13/17.

Inscribing the magnet strip 101 and/or the electronic chip 103 can be performed optionally on the forward movement of the card or on the backward movement of the card 100 through the electronic unit 13/17.

The rear end portion furthermore illustrates the suction extraction device 15 which sucks air from the inscribing location and exhausts it through an active charcoal filter 16 from the housing of the device which is not illustrated in the figures.

The sidewall 28 visible in the FIGS. 2A, 2C and 3B however is primarily used for stabilizing the internal configuration and for air guidance when suctioning from the inscribing location.

### REFERENCE NUMERALS AND DESIGNATIONS

1 laser source
2 optics
3 fan mirror
4 card slide
5 deflection mirror
7, 7′ deflection mirror
8, 8′ deflection mirror
9 selection mirror
9′ deflection mirror
10 laser beam path
10′ beam fan
11 pivot axis
12a, b support
13 electronic inscribing unit
14 prism
15 suction extraction device
17
18
19 CCD chip
20 viewing direction
21 pivot axis
22, 22′ mirror support
23 deflection mirror
24 motor
25 linear incremental encoder
26 support plate
27 insertion slot
28 sidewall
29 magnet
100 card
100a top side
100b bottom side
100′ main plain, center main plane
101 magnetic strip
102 initial imprint
103 chip

We claim:

1. A laser inscribing device for both sides of a card with a main plane extending in an X-direction and a Y-direction, comprising:
a laser source;
optics focusing the laser source;
a fan mirror in the beam path of the laser beam, wherein the fan mirror pivots back and forth in an oscillating manner in Y-direction;
at least one stationary deflection mirror for the laser beam, wherein the laser beam oscillating in Y-direction on the card surface is always oriented towards the same Y-position of the device;
a card slide or an optical slide that is moveable in a controlled manner in X-direction; and
a control of the device which controls the X-movement of the card slide and a triggering of a laser impact as a function of an angular position of the fan mirror and of the X-position of the card slide.

2. The laser inscribing device according to claim 1, wherein the control controls operating parameters of the laser source in particular for each individual laser shot.

3. The laser inscribing device according to claim 1, wherein the card slide only includes peripheral receivers for the card;
wherein the device includes at least one stationary deflection mirror analogously on both sides of the main plane of the card slide; and
wherein a selection mirror that is pivotable back and forth between two positions for the top side and the bottom side of the card is arranged in front of the stationary deflection mirrors in the beam path of the laser so that the laser beam is deflected on a first side or a second side with respect to the main plane of the card slide and the deflection mirrors.

4. The device according to claim 1, wherein the exterior mirror is pivotable by ninety degrees between the two positions.

5. The device according to claim 1, wherein the laser source emits the laser beam in a direction parallel to the center main plane of the card slide, in particular in the center main plane of the card slide and the selection mirror is arranged about a pivot axis extending in Y-direction adjacent to the card slide.

6. The device according to claim 1, wherein the laser beam is deflected in particular by the at least one stationary deflection mirror in a direction opposite to the emission direction from the laser source.

7. The device according to claim 1, wherein the mirror is arranged so that the focal point of the laser beam independently from the position of the moveable mirror is always on the surface of the card arranged in the card slide.

8. The device according to claim 1, wherein the supports for the card slide have an adjustment transversal to the main plane of the X-Y plane or the card slide is replaceable.

9. The device according to claim 1, wherein the optics for the laser beam are arranged in the beam path behind of the fan mirror and the before the selection mirror.

10. The device according to claim 1, wherein three respective stationary deflection mirrors are arranged in the beam path of the laser and the deflection mirrors respectively have the same dielectric coating and are mounted under identical reflection conditions in particular respectively with a beam deflection of ninety degrees.

11. The device according to claim 1, wherein the movement path of the card slide is a straight flat movement path.

12. The device according to claim 1, wherein a magnet inscribing unit for the magnet strip of the card is arranged in front of the movement path of the card slide.

13. The device according to claim 1, wherein the transport path in the magnet inscribing unit is aligned with the movement direction of the card slide and an automatic handover device from the electronic inscribing unit into the card slide is provided there between.

14. The device according to claim 1, wherein the device includes a prism for impinging the laser beam at a slant angle onto the card surface or a slanted mirror, in particular on each side of the main plane of the card slide, wherein the prism or the slanted mirror are moveably arranged so that they are configured to be moved in and out of the beam path of the laser beam.

15. The device according to claim 1, wherein the prism is positionable between the last fixated deflection mirror and the card slide in the beam path.

16. The device according to claim 1, wherein the device includes a suction extraction device for air provided at the inscribing location, wherein the suction extraction device includes an active charcoal filter through which the extracted air is conducted.

17. The device according to claim 1, wherein the device includes a chip inscribing unit for inscribing the electronic chip of the card in addition to the magnetic inscribing unit.

18. The device according to claim 1, wherein the device includes an optical sensor, in particular a CCD chip with a viewing direction transversal to the main plane of the card slide and in particular oriented to the start position of the card slide in which the card is inserted.

19. The device according to claim 1, wherein the X-direction is the largest extension of the card.

20. A method for laser inscribing cards extending in X- and Y-directions,
wherein a laser beam oscillating in Y-direction on the card surface is always oriented towards an identical Y-position of the device,
wherein a card slide is moved in a controlled manner in X-direction; and
wherein and X-movement of the card slide and triggering a laser shot out of the laser source is controlled as a function of the angular position of the fan mirror and the X-position of the card slide.

21. The method according to claim 20, wherein the card is supported in the card slide only in the edge portions not to be inscribed and the laser beam is optionally directed to the top side or the bottom side of the card in the card support.

22. The method according claim 20, wherein the laser beam is emitted by the laser beam source in a direction parallel to the center main plane of the card slide, in particular in the center main plane of the card slide.

23. The method according to claim 20, wherein the inscribing areas or inscribing types which respectively require identical laser process parameters are respectively inscribed in one process step.

24. The method according to claim 20, wherein the card slide is moved straight, in particular in aligned extension of the movement path of the card in a predisposed electronic inscribing unit and/or for the magnetic strip and/or the chip on the card.

25. The method according to claim 20, wherein air that is contaminated in the interior of the device during laser inscribing is conducted to the outside through a filter, in particular a charcoal filter.

26. The method according to claim 20, wherein visible elements provided on the card to be inscribed are scanned by an optical sensor with respect to their actual positions on the card before inscribing the card and the actual positions are compared with a target positions and the positions of the laser inscribings to be applied to the card are varied accordingly when a deviation is too strong.

27. The method according to claim 20, wherein the exit direction of the laser beam can be switched from orthogonal to the card surface to a slanted position for obtaining an inscribing according to the CLI method or the MLI method.
